(19) United States
(12) Patent Application Publication
(10) Pub. No.: US 2020/0333666 A1
(43) Pub. Date: Oct. 22, 2020

(54) DISPLAY DEVICE, DISPLAY METHOD, AND NON-TRANSITORY COMPUTER-READABLE STORAGE MEDIUM

(71) Applicant: SHARP KABUSHIKI KAISHA, Sakai City, Osaka (JP)

(72) Inventor: NAOHIRO HOHJOH, Sakai City, Osaka (JP)

(21) Appl. No.: 16/959,907

(22) PCT Filed: Dec. 28, 2018
(86) PCT No.: PCT/JP2018/048495

§ 371 Date: Jul. 2, 2020

(30) Foreign Application Priority Data
Jan. 10, 2018 (JP) 2018-001777

(51) Int. Cl. G02F 1/13357; G09G 3/22

(52) U.S. Cl. CPC G02F 1/133611; G09G 3/22; G09G 2360/18; G09G 2300/0465; G09G 2320/0233; G09G 2330/021

(57) ABSTRACT

A display device includes a power consumption calculation unit configured to calculate total power consumption of a plurality of light sources in displaying an input video; a ratio determining unit configured to determine a scale-down ratio or a cut-out ratio for the video based on a relationship between a prescribed maximum display luminance for a given pixel and a preset, specified display luminance that is a maximum value of display luminance for a faithful luminance display, the prescribed maximum display luminance being predetermined so as to be achievable at the total power consumption calculated by the power consumption calculation unit and a display control unit configured to process the video in accordance with the scale-down ratio or cut-out ratio determined by the ratio determining unit.

### TECHNICAL FIELD

The present disclosure relates to video display devices.

### BACKGROUND ART

Standardization work has been under way on HDR (high dynamic range)-based television broadcasting for better reproduction of visual texture or live feel. ITU-R BT. 2100 provides two techniques: HLG (hybrid log-gamma) and PQ (perceptual quantization). Either technique delivers a far greater dynamic range than conventional television standards.

The HDR video allows for a maximum white luminance of 10,000 nits for the purpose of satisfactory reproduction of brightness found in the real world (natural environment). However, the maximum luminance (display peak luminance) determined on the basis of the maximum display capability of the HDR video display device is as high as 4,000 nits in some display devices, but generally no higher than 1,000 nits. It is therefore necessary to prepare content including an HDR video or display an HDR video in such a manner that the HDR video/content can be displayed on the low-spec display device.

An HDR video is typically subjected to tone mapping including a knee curve process in order not to exceed the maximum display luminance of the display device. However, if a knee curve process is performed separately for each RGB color, the HDR video is undesirably not reproduced in its original colors.

Patent Literature 1 discloses a technique that addresses these problems by converting a part of a PQ curve to a gamma curve under the following conditions: (i) the original MaxCLL value (e.g., 800 nits) of the HDR video should be adjusted in accordance with the maximum display luminance of the display device (e.g., 750 nits), and (ii) the relative relationship of the 0 to 800 nit luminance levels should be preserved on the PQ curve (or on a part of the PQ curve). The MaxCLL (maximum content light level) is information representing a maximum display luminance in a title or scene of an HDR video.

### CITATION LIST

### Patent Literature

Patent Literature 1: Japanese Unexamined Patent Application Publication, Tokukai, No. 2016-213809 (Publication Date: Dec. 15, 2016)

### SUMMARY OF INVENTION

### Technical Problem

The technique of Patent Literature 1 however has problems of low display luminance reproducibility in low and intermediate luminance regions.

In addition, the maximum display luminance of a display device can change with conditions such as the average luminance level of the HDR video. For instance, the maximum display luminance actually achieved in displaying an HDR video may be as low as 20% of the predetermined display peak luminance of the display device or even lower, depending on display conditions. It is therefore difficult to reproduce, in displaying the video, the luminance intended by a videographer or producer who filmed or produced the HDR video.

The present disclosure, in an aspect thereof, has an object to improve the reproducibility of the original luminance of a video in displaying the video.

### Solution to Problem

To address the problems, the present disclosure, in an aspect thereof, is directed to a display device including: a power consumption calculation unit configured to calculate total power consumption of a plurality of light sources in displaying an input video; a ratio determining unit configured to determine a scale-down ratio or a cut-out ratio for the video based on a relationship between a prescribed maximum display luminance for a given pixel and a preset, specified display luminance that is a maximum value of display luminance for a faithful luminance display, the prescribed maximum display luminance being predetermined so as to be achievable at the total power consumption calculated by the power consumption calculation unit; and a display control unit configured to process the video in accordance with the scale-down ratio or cut-out ratio determined by the ratio determining unit.

To address the problems, the present disclosure, in an aspect thereof, is directed to a display method including: the power consumption calculation step of calculating total power consumption of a plurality of light sources in displaying an input video; the ratio determining step of determining a scale-down ratio or a cut-out ratio for the video based on a relationship between a prescribed maximum display luminance for a given pixel and a preset, specified display luminance that is a maximum value of display luminance for a faithful luminance display for a given pixel, the prescribed maximum display luminance being predetermined so as to be achievable at the total power consumption calculated in the power consumption calculation step; and the display control step of processing the video in accordance with the scale-down ratio or cut-out ratio determined in the ratio determining step.

### Advantageous Effects of Invention

The present disclosure, in an aspect thereof, is capable of improving the reproducibility of the original luminance of a video in displaying the video.

### BRIEF DESCRIPTION OF DRAWINGS

FIG. 1 is a block diagram of an exemplary structure of a display device in accordance with Embodiment 1.

FIG. 2 is a set of illustrations of a scale-down ratio and a cut-out ratio, with (a) of FIG. 2 showing an exemplary scaled-down video and (b) of FIG. 2 showing an exemplary cut-out video.

FIG. 3 is a graph representing a relationship between the total power consumption of a backlight in the display device in accordance with Embodiment 1 and a maximum display luminance of the display device.

FIG. 4 is a diagram showing exemplary power consumption data calculated on the basis of an input video signal.

FIG. 5 is a flow chart representing an exemplary process in a display device.

FIG. 6 is a graph representing a relationship between the total power consumption of a backlight in a display device in accordance with Embodiment 2 and a maximum display luminance of the display device.

FIG. 7 is a set of illustrations of exemplary display screens in accordance with Embodiment 2, with (a) of FIG. 7 showing an exemplary multivideo display screen generated when a scaled-down video is displayed and (b) of FIG. 7 showing an exemplary multivideo display screen generated when a cut-out video is displayed.

FIG. 8 is a diagram showing exemplary power consumption data calculated on the basis of an input video signal in a display device in accordance with Embodiment 3.

FIG. 9 is an illustration of a scaled-up display of a cut-out area on the display device in accordance with Embodiment 3.

FIG. 10 is an illustration of a scaled-up display of a cut-out area on a display device in accordance with a variation example of Embodiment 3.

FIG. 11 is a block diagram of an exemplary structure of a display device in accordance with Embodiment 4.

### DESCRIPTION OF EMBODIMENTS

### Embodiment 1

The following will describe an embodiment of the present disclosure.

### Structure of Display Device

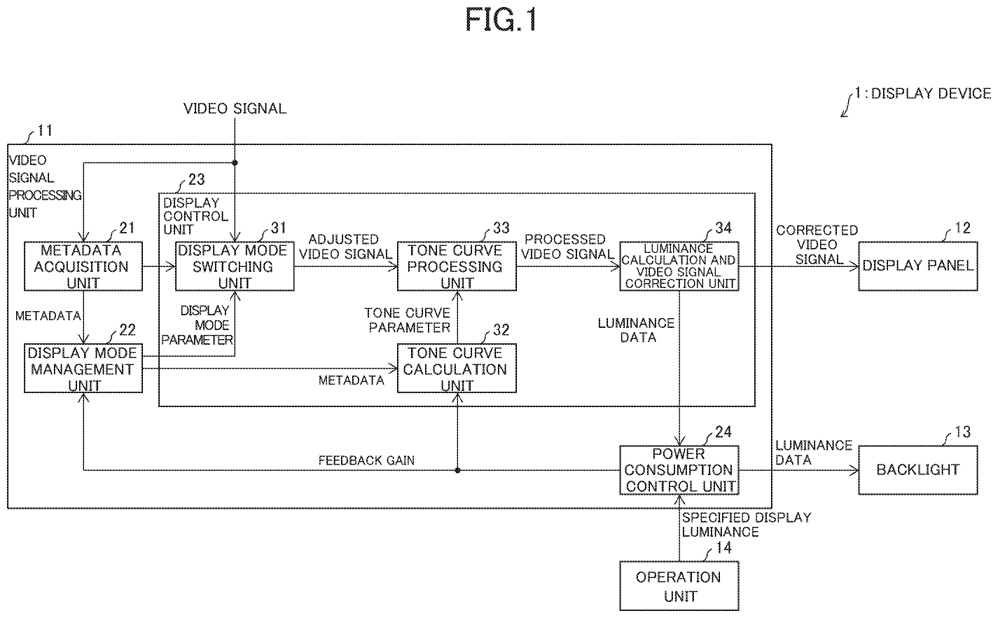

FIG. 1 is a block diagram of an exemplary structure of a display device 1 in accordance with the present embodiment. Referring to FIG. 1, the display device 1 includes a video signal processing unit 11, a display panel 12 (display unit), a backlight 13 (display unit), and an operation unit 14.

The video signal processing unit 11 performs various processes on video signals fed to the display device 1. In the present embodiment, the video signal processing unit 11 has a so-called local dimming function of displaying a video on the display panel 12 by separately controlling the turning-on/off of a plurality of light sources in the backlight 13. In the display device having a local dimming function, the light sources are separately turned on/off in accordance with the video to be displayed, which translates into different power consumption levels of the light sources in accordance with the video to be displayed. Power consumption levels differ in accordance with the video to be displayed in a similar manner in display devices including self-luminous elements such as the OLED (organic light-emitting diode) display device. A detailed description of the OLED will be given later in Embodiment 4.

The video signal represents an HDR video that is in compliance with the HDR standard. The video signal (video content) is fed to the display device 1 as television broadcasts, via a various package medium, or over a network. The video signal may represent either a moving image or a still image.

The display panel 12 displays a video represented by a video signal that is processed by the video signal processing unit 11 (corrected video signal). The display panel 12 is a liquid crystal panel in the present embodiment.

The backlight 13 is a light source with a light-emitting face that serves as an area light source. The light-emitting face of the backlight 13 is divided into a plurality of areas and allows separate luminance adjustment for each area. The backlight 13 adjusts the luminance of each area thereof on the basis of the luminance data supplied from the video signal processing unit 11.

The operation unit 14 receives inputs based on a user operation. The operation unit 14, in the present embodiment, receives an input of a value representing a specified display luminance that is a maximum display luminance needed to perform a faithful luminance display as specified in advance by a user.

This specified display luminance is supposed to have been specified by a user as a limit value of the display luminance with which the video represented by the input video signal can be correctly displayed on the display device 1. A “correct display” is, for example, a display with no changes being made to the luminance value of an object imaged using a camera. In other words, a “correct display” is a video display based on an input video with the best possible reproducibility. Specifically, a “correct display” is a display of a video with a luminance faithful to the luminance value represented by the input video (e.g., with the same luminance as the luminance value represented by the input video).

For instance, when a display is produced on the display device 1 by the PQ technique described above, the pixel value (e.g., grayscale level or luminance value) for a pixel in an input video uniquely corresponds to the absolute value of the luminance used for that pixel in producing the display on the display device 1 if the pixel value is less than or equal to the specified display luminance. Therefore, in the PQ technique, a “faithful luminance display” is a display with a display luminance corresponding to the pixel value for the pixel in the input video.

Meanwhile, when a display is produced, for example, on the display device 1 by the HLG technique described above, there is a relative relationship between a pixel value and the absolute value of the luminance used for the pixel in producing the display on the display device 1 if the pixel value for the pixel in the input video is less than or equal to the specified display luminance. Accordingly, for example, by defining the display luminance as matching the display peak luminance of the display device 1 when the pixel value for the pixel in the input video has the maximum pixel value in the video, the relationship becomes fixed between the pixel value for the pixel in the input video and the absolute value of the luminance used for the pixel in producing the display on the display device. Therefore, a “faithful luminance display” in the HLG technique is a display produced with a display luminance determined in this manner.

In a stricter sense of the term, a “faithful luminance display,” in either technique, is a display with a fixed display luminance which does not vary with the video content. For instance, the display luminance can vary with video content in a display device in accordance with a comparative example described later.

By setting the specified display luminance to a value that is as close as possible to the display peak luminance of the display device 1, a display can be produced with a luminance that is close to the display peak luminance and also to the luminance value represented by the video signal.

A maximum display luminance is a display luminance dictated by the total power consumption needed to actually display an input video. Meanwhile, a display peak luminance is a maximum luminance of the display device 1 dictated by the specifications of the display device 1 and achieved only under good conditions such as when a video is displayed with the total power consumption being less than or equal to a prescribed value. In other words, the maximum value of the maximum display luminance is equal to the display peak luminance.

It is sufficient if the specified display luminance is preset before the video signal processing unit 11 processes a video signal. The user is not necessarily a viewer of the video displayed on the display device 1 and may alternatively be, for example, the provider of the video signal (e.g., producer of the video content) or the manufacturer of the display device 1. In other words, anyone can set the specified display luminance so long as the specified display luminance is set as described above. As another alternative example, a program, instead of a user, may set the specified display luminance.

### Structure of Video Signal Processing Unit

The video signal processing unit 11 primarily includes a metadata acquisition unit 21, a display mode management unit 22 (ratio determining unit), a display control unit 23, and a power consumption control unit 24 (power consumption calculation unit), to perform the various processes.

The metadata acquisition unit 21 acquires metadata accompanying a video signal. By acquiring the metadata, the metadata acquisition unit 21 determines whether the input video signal complies with the HDR standard or the SDR (standard dynamic range) standard. If the input video signal complies with the HDR standard, the metadata acquisition unit 21 identifies the input video signal as complying with the HDR standard in the present embodiment. In addition, if the metadata acquisition unit 21 identifies the video signal as complying with the HDR standard, the metadata acquisition unit 21 identifies the type of the HDR standard. The metadata acquisition unit 21 may acquire, from the metadata, maximum luminance data representing a maximum luminance of the video signal in a period.

The display mode management unit 22 determines the display mode of the input video signal (the display ratio of the input video). Specifically, the display mode management unit 22 determines the scale-down or cut-out ratio for a video on a basis of a relationship between a prescribed maximum display luminance in a given pixel predetermined to be capable of displaying the video at the total power consumption calculated by the power consumption control unit 24 and the specified display luminance predetermined for a faithful luminance display.

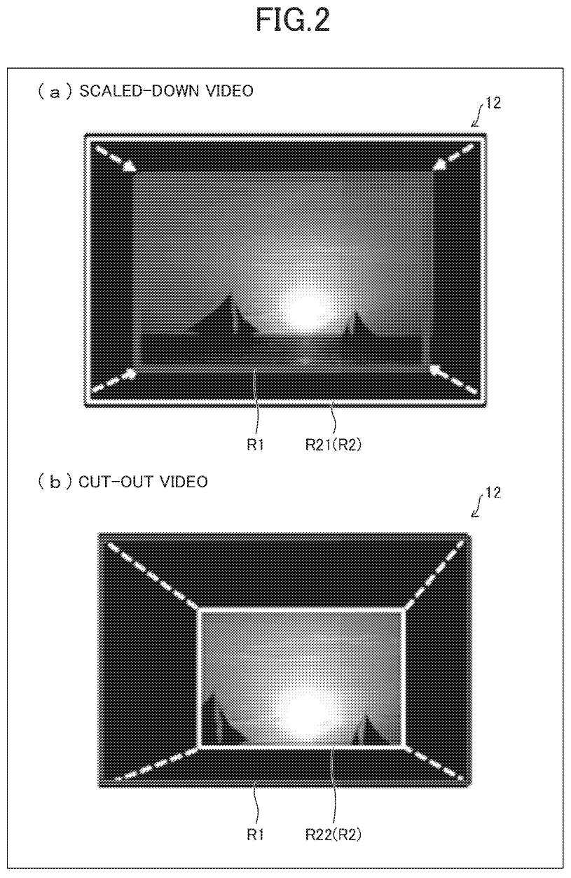

FIG. 2 is a set of illustrations of a scale-down ratio and a cut-out ratio, with (a) of FIG. 2 showing an exemplary scaled-down video and (b) of FIG. 2 showing an exemplary cut-out video.

The scale-down ratio is a ratio of the size of a display area (display frame) R21 to the size of a video displayed in the display area R21 of the display panel 12 (“video entire area” R1). The cut-out ratio is a ratio of the size of a cut-out area (display frame) R22 cut out of the video entire area R1 to the size of the video entire area R1 displayed in the display area R21 of the display panel 12. The display area R21 and the cut-out area R22 may be hereinafter collectively referred to as display frames R2.

The display ratio is equal to 1 when the video entire area R1 is displayed across the display area R21 and equal to 1 when the cut-out area R22 occupies the whole video entire area R1. In other words, the display ratio is equal to 1 when the display frame R2 is equal to the video entire area R1. Meanwhile, the display ratio corresponds to the “scale-down ratio” when the display frame R2 (display area R21) is greater than the video entire area R1 (i.e., when the display ratio is greater than 1) and corresponds to the “cut-out ratio” when the display frame R2 (the cut-out area R22) is smaller than the video entire area R1 (i.e., when the display ratio is less than 1).

The display ratio may be a ratio of the length of a side of the displayed video entire area R1 and the length of a side of the display area R21 or the cut-out area R22 that corresponds to a side of the video entire area R1.

The display device 1 displays a scaled-down video obtained by scaling down the input video in accordance with a scale-down ratio when the display frame R2 (display area R21) is greater than the video entire area R1 as shown in (a) of FIG. 2. Meanwhile, the display device 1 displays a part of the input video that is cut out in accordance with the cut-out ratio together with a black display (grayscale level of 0) in the area other than the resultant cut-out area R22 when the display frame R2 (cut-out area R22) is smaller than the video entire area R1 as shown in (b) of FIG. 2. The video containing the cut-out area R22 corresponds to the cut-out video. The video in the cut-out area R22 is neither a scaled-up version nor a scaled-down version of the input video, but a part of the original-size input video.

In other words, the display device 1, including the display mode management unit 22, displays, on the basis of the specified display luminance, either a scaled-down video obtained by scaling down the input video in accordance with a scale-down ratio or a cut-out video obtained by cutting out a part of the input video in accordance with a cut-out ratio.

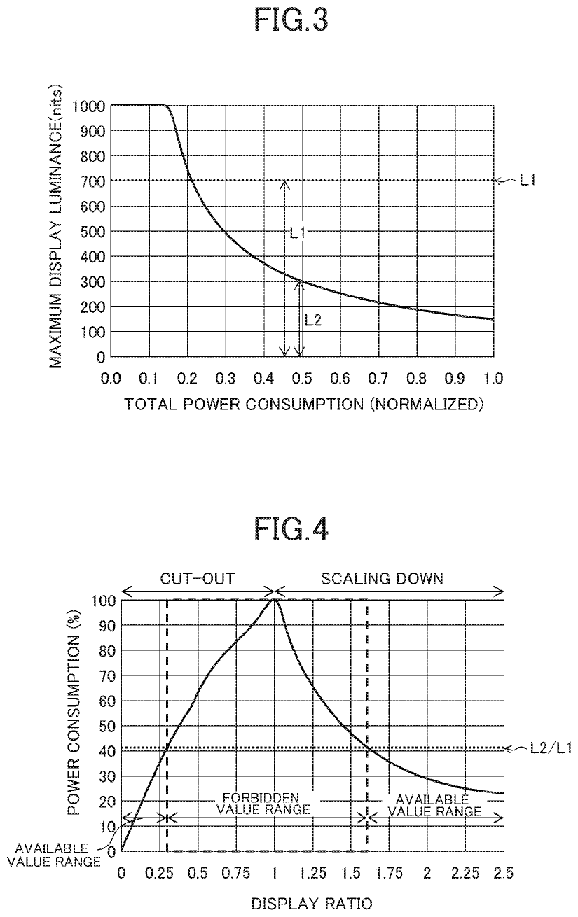

FIG. 3 is a graph representing a relationship between the total power consumption of the backlight 13 and the maximum display luminance of the display device 1. The graph shows the normalized total power consumption of the backlight 13 on the horizontal axis and the maximum display luminance of the display device 1 on the vertical axis. There is a correlation between the maximum display luminance of a given pixel and the total power consumption of the backlight 13 as shown in FIG. 3. The display device 1 is capable of a video display with a higher display luminance at a smaller total power consumption. As also shown in FIG. 3, the maximum display luminance remains unchanged at 1,000 nits when the total power consumptions is less than or equal to approximately 0.15. Accordingly, the display device 1 ha a display peak luminance of 1,000 nits in the present example.

The total power consumption of the backlight 13 and the maximum display luminance of the display device 1 has the relationship represented in FIG. 3 for the following reasons. Take, as an example, an image that includes a thoroughly white rectangle accounting for 5% of the area of the image with the rest of the image being thoroughly black (“image A”) and an image that is entirely white (“image B”). When the display device 1 displays image A, the backlight 13 needs only to turn on the light sources in the thoroughly white rectangle, so that the display device 1 can operate on small electric power. On the other hand, when the display device 1 displays image B, the backlight 13 needs to turn on all the light sources, so that the display device 1 requires large electric power.

Typical power supplies for display devices are not capable of delivering sufficient electric power for all the light sources in the backlight to emit light at the maximum luminance thereof, due to heat generation and cost for such a power supply. For these reasons, the display device may be in some cases controlled such that those light sources in the area of the thoroughly white rectangle emit light with high luminance when image A is displayed and such that all the light sources emit light with limited luminance when image B is displayed, in order to reduce power consumption. Simply performing such control will result in the display luminance of the pixels in the equally thoroughly white areas differing between image A and image B. In other words, the display luminance can vary with video content.

Now, a display device (comparative example) is discussed that has no specified display luminance setting and includes no display mode management unit 22. The output of the backlight 13 is adjusted as in the graph in FIG. 3 in the display device in accordance with the comparative example.

Specifically, if the total power consumption calculated for the input video is less than or equal to a prescribed value, the power consumption control unit 24 controls an output in each area of the backlight 13 in accordance with a backlight luminance calculated by a luminance calculation and video signal correction unit 34 on the basis of the video signal. The power consumption control unit 24 performs the control when, for example, in the graph in FIG. 3, the total power consumption is less than or equal to approximately 0.15, which is a maximum total power consumption at which a video can be displayed with the maximum display luminance of 1,000 nits (display peak luminance). For moving images, the total power consumption and backlight luminance are calculated for the entire frame period.

On the other hand, when the total power consumption is in excess of a prescribed value (e.g., approximately 0.15 in the graph in FIG. 3), the power consumption control unit 24 controls an output in each area on the basis of, for example, a value obtained by uniformly reducing the backlight luminance by a prescribed ratio in each area. For instance, in the graph in FIG. 3, when the total power consumption is equal to 0.5, the prescribed ratio is equal to the maximum display luminance (L2) divided by the specified display luminance (L1). The power consumption control unit 24 thus controls such that the total power consumption remains less than or equal to the prescribed value. In this situation, the power consumption control unit 24 may output the prescribed ratio (L2/L1) as a feedback gain value to a tone curve calculation unit 32 described later. This output enables display luminance in a low luminance area of a video to be corrected in such a manner as to approach the original luminance of the low luminance area.

As detailed here, the display device in accordance with the comparative example is capable of a video display with the display peak luminance (1,000 nits) of the display device only under such good conditions that the video can be displayed with the total power consumption remaining less than or equal to a prescribed value (approximately 0.15). In other words, the display device in accordance with the comparative example will have difficulty in producing the display if the video needs to be displayed with the total power consumption exceeding the prescribed value. In the example in FIG. 3, if the total power consumption is equal to 0.5 (in normalized value) as an example, the display device in accordance with the comparative example is only capable of a display up to a maximum display luminance of 300 nits.

The display device 1 in accordance with the present embodiment has a specified display luminance setting and includes the display mode management unit 22. The display device 1 is hence capable of producing a display up to the specified display luminance.

The following will describe specific processes performed by the display mode management unit 22. The display mode management unit 22 generates power consumption data representing a relationship between a display ratio and a relative value obtained based on the total power consumption corresponding to the display ratio. The power consumption data may be prepared in the form of a table.

The display mode management unit 22 compares the generated power consumption data with the luminance ratio that is the ratio of the prescribed maximum display luminance to the specified display luminance. If the prescribed maximum display luminance is less than the specified display luminance, the display mode management unit 22 then designates, as an available value range of a video scale-down ratio or a video cut-out ratio, a display ratio for which the relative value obtained based on the total power consumption is less than or equal to the luminance ratio in the power consumption data.

The luminance ratio is the ratio (L2/L1) of the maximum display luminance L2 (prescribed maximum display luminance) of the display device 1 at a given total power consumption to the specified display luminance L1 as specifically shown in FIG. 3.

The specified display luminance L1 is set to 700 nits in the present embodiment. Therefore, for example, when the total power consumption (in normalized value) calculated by the power consumption control unit 24 is equal to 0.5, the luminance ratio is calculated as in L2/L1=300/700 nits≈0.43 (43%). In other words, in such a case, the display mode management unit 22 determines that the maximum display luminance L2 is less than the specified display luminance L1.

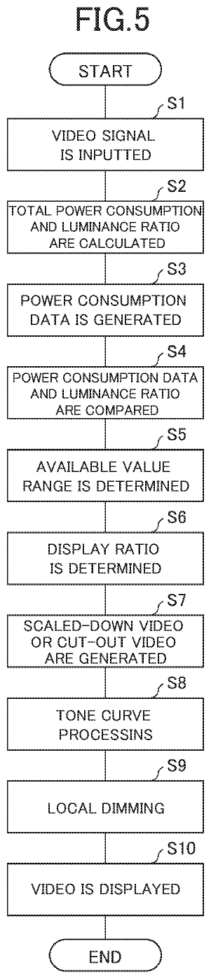

FIG. 4 is a diagram showing exemplary power consumption data calculated on the basis of an input video signal. FIG. 4 is a graphical representation of power consumption data with the display ratio plotted on the horizontal axis and the relative value obtained based on the total power consumption plotted on the vertical axis. The relative value obtained based on the total power consumption is given by using, as the reference, the total power consumption when the display ratio is equal to 1. The example shown in FIG. 4 uses, as the relative value obtained based on the total power consumption, values from 0% to 100%, both inclusive, obtained by converting the total power consumption (power consumption %). The converted value corresponds to the luminance ratio (L2/L1).

The display mode management unit 22, upon determining that the maximum display luminance L2 is less than the specified display luminance L1, generates the power consumption data representing the correspondence between the relative value obtained based on the 100% or less total power consumption and the display ratio including both the scale-down ratio and the cut-out ratio as shown in FIG. 4.

When the display frame R2 is larger than the video entire area R1 (see (a) of FIG. 2), the total power consumption can vary depending on the number and layout of the areas designated in the backlight 13 and decreases primarily with a decrease in the area of the video entire area R1. The larger the number of the designated areas, the lower the power consumption of the backlight. The power consumption data shown in FIG. 4 has values that can vary depending on the number and layout and also on the area of the video entire area R1 in a range where the display ratio is greater than 1. Since the video is displayed across the entire display area when the display ratio is equal to 1, all the light sources in the backlight 13 are to be controlled. Therefore, the total power consumption is a maximum in this situation. The relative value obtained based on the total power consumption is hence set to 100%.

On the other hand, when the display frame R2 is smaller than the video entire area R1 (see (b) of FIG. 2), the total power consumption can vary depending on the video signal and increases when a high luminance object is locally present in the video entire area RI. In other words, when the display frame R2 is smaller than the video entire area R1, the total power consumption can vary depending on the display frame position (cut-out position) (x, y) where the display frame R2 is specified. Accordingly, the two parameters of the cut-out position (x, y) are explored for various display ratios for the input video, in order to calculate the maximum value of the total power consumption for the value of each display ratio in advance. This calculation may be performed by the power consumption control unit 24 on the basis of the luminance data representing the backlight luminance. Based on results of this calculation, in the power consumption data shown in FIG. 4, the total power consumption is a maximum when the display ratio is equal to 1 and a minimum when the display ratio (cut-out ratio) is equal to 0. For these reasons, the relative value obtained based on the total power consumption when the display ratio is equal to 1 is taken as 100%, and the relative value obtained based on the total power consumption when the display ratio is equal to 0 is taken as 0%. This generation of power consumption data provides power consumption data that does not depend on the cut-out position.

Therefore, in the power consumption data shown in FIG. 4, the relative value is a maximum if obtained based on the total power consumption when the display ratio is equal to 1 and monotonically decreases as the display ratio grows larger or smaller than 1.

As described above, if the specified display luminance is 700 nits, and the total power consumption (in normalized value) calculated by the power consumption control unit 24 is 0.5, the luminance ratio is L2/L1=300/700 nits≈0.43 (43%). In such a case, the display mode management unit 22 compares the power consumption data calculated on the basis of the input video signal with the luminance ratio as shown in FIG. 4, and as a result, determines, as available value ranges, a range of approximately 0.3 or smaller and a range of approximately 1.6 or greater where the relative value obtained based on the total power consumption is less than or equal to the luminance ratio.

As described above, the range in which the display ratio is less than 1 corresponds to cut-out ratios, and the range in which the display ratio is greater than 1 corresponds to scale-down ratios. Therefore, the available value range of approximately 0.3 or smaller is determined as a range in which a cut-out ratio can be specified, and the available value range of approximately 1.6 or greater is determined as a range in which a scale-down ratio can be specified. The range of the display ratio outside the available value ranges is a forbidden value range as shown in FIG. 4.

The display mode management unit 22 further determines a scale-down ratio or a cut-out ratio as a display ratio in the determined available value range. If the video is a moving image, from the viewpoint of continuous display, the display mode management unit 22 selects, for example, for a target frame that is a display target, a display ratio that is close to the display ratio of the preceding frame from the display ratios in the available value range. On the other hand, for the first frame of a video that is a moving image or for a still image, the display mode management unit 22 determines a display ratio by a predetermined method. For instance, the display mode management unit 22 may select a display ratio near a boundary of an available value range and a forbidden value range within the available value range.

If there is a plurality of cut-out areas that can be cut out using the determined cut-out ratio, the display mode management unit 22 designates one of the plurality of cut-out areas as the cut-out area R22 that is to be actually cut out. By this designation, the display mode management unit 22 identifies the location of the cut-out area R22 in the input video. The display mode management unit 22 may identify a location corresponding to the cut-out area R22 cut out in the preceding frame as the location in the target frame where the cut-out area R22 is to be cut out. Alternatively, the display mode management unit 22 may identify that location by a predetermined method.

The display mode management unit 22 transmits, to the display control unit 23, display mode parameters including a determined scale-down or cut-out ratio and other specified values that accompany this. The values included in the display mode parameters are, for example, a value representing a display format (scaled-down video display/cut-out video display), a scale-down ratio for a video, a display-starting position (x0, y0), a display-ending position (x1, y1), a cut-out-starting position (xin0, yin0), and a cut-out-ending location (xin1, yin1).

If the luminance ratio L2/L1 is greater than or equal to 1, the display device 1 may display the input video without making any modifications to the input video similarly to the display device in accordance with the comparative example. In other words, the display device 1 may control the turning on/off of the backlight 13 using the backlight luminance calculated on the basis of the input video signal or using values obtained by reducing the calculated backlight luminance, without generating a scaled-down video or a cut-out video. This reduction of the backlight luminance is not performed uniformly across all the grayscale levels. By the power consumption control unit 24 outputting a feedback gain value to the tone curve calculation unit 32, the display device 1 produces an accurate luminance display for the low and intermediate luminance areas of less than or equal to the specified display luminance L1 in the input video.

A portion of the video may be scaled up before being displayed if the luminance ratio L2/L1 is greater than 1 as detailed in Embodiment 3. The display mode parameters in such a case include a value representing a scaled-up display as a display format and a video scale-up ratio.

The display control unit 23 processes the input video in accordance with the scale-down or cut-out ratio determined by the display mode management unit 22 to generate a video to be displayed on the display panel 12. The display control unit 23 includes a display mode switching unit 31, the tone curve calculation unit 32, a tone curve processing unit 33, and the luminance calculation and video signal correction unit 34.

The display mode switching unit 31 switches the display mode in accordance with the display mode parameters fed from the display mode management unit 22. Specifically, the display mode switching unit 31 generates a scaled-down video or a cut-out video as a result of the display mode switching, by subjecting the input video signal to scaling or other adjustment. The display mode switching unit 31 also performs processes (e.g., scaling and display position adjustment) that enable a video window display or a multivideo display (see Embodiment 2) in accordance with the display mode parameters. The display mode switching unit 31 outputs the adjusted video signal to the tone curve processing unit 33.

The tone curve calculation unit 32 analyzes the metadata obtained by the metadata acquisition unit 21 to identify an EOTF (electro-optical transfer function) defined for each HDR standard. The tone curve calculation unit 32 calculates a tone curve (specifically, a look-up conversion table) such that a process can be performed, for example, to apply a knee curve to the EOTF in accordance with the maximum display luminance that is the actual maximum display capability that differs from one display device 1 to the other similarly to the conventional technique. The tone curve calculation unit 32 outputs the calculated look-up conversion table to the tone curve processing unit 33 as a tone curve parameter. When the video is a moving image, the tone curve is calculated for each frame.

The tone curve processing unit 33 applies a tone curve to the adjusted video signal fed from the display mode switching unit 31 (for each frame for a moving image), by using the look-up conversion table calculated by the tone curve calculation unit 32 and also using a computing circuit. Luminance conversion is hence performed on the video signal. A tone curve is applied, in the present embodiment, to a scaled-down or cut-out video generated on the basis of the display mode determined by the display mode switching unit 31. The tone curve processing unit 33 outputs the tone-curve applied video signal (processed video signal) to the luminance calculation and video signal correction unit 34.

The luminance calculation and video signal correction unit 34 displays on the display panel 12 the scaled-down or cut-out video to which a tone curve is applied by the tone curve processing unit 33 by using a so-called local dimming function. Specifically, with the display panel 12 and the backlight 13 being divided into a plurality of areas, the luminance calculation and video signal correction unit 34 calculates a backlight luminance for the backlight 13 in accordance with the original luminance of the video to be displayed in each area of the display panel 12. The luminance calculation and video signal correction unit 34 also adjusts the original luminance of the video in accordance with the calculated backlight luminance.

The luminance calculation and video signal correction unit 34 outputs the luminance data representing the calculated backlight luminance to the power consumption control unit 24. The luminance calculation and video signal correction unit 34 also outputs to the display panel 12 a corrected video signal representing a video having adjusted luminance. The display panel 12 displays a video represented by the corrected video signal.

The power consumption control unit 24 manages the total power consumption such that the total power consumption is less than or equal to a prescribed value, by calculating the total power consumption of the backlight 13 in displaying the input video.

The power consumption control unit 24, in the present embodiment, calculates the total power consumption corresponding to the display ratio and outputs a result of the calculation to the display mode management unit 22 as a feedback gain value. This enables the display mode management unit 22 to generate the power consumption data.

The power consumption control unit 24 also calculates the ratio of the maximum display luminance L2 of the display device 1 at a given total power consumption to the specified display luminance L1 entered via the operation unit 14 (luminance ratio L2/L1), for output as a feedback gain value to the display mode management unit 22. This enables the display mode management unit 22 to determine an available value range by comparing the power consumption data and the luminance ratio.

The power consumption control unit 24 also calculates total power consumption in outputting a scaled-down video or a cut-out video on the basis of the luminance data fed from the luminance calculation and video signal correction unit 34. The power consumption control unit 24 also outputs the luminance data to the backlight 13 to control the output of the backlight 13 based on a local dimming function.

The power consumption control unit 24 may output the luminance ratio to the tone curve calculation unit 32 as a feedback gain value, similarly to the display device in accordance with the comparative example. In such a case, the display luminance in low luminance areas of a video can be corrected to approach the original luminance of the low luminance area.

### Display Device Controlling Method

A description will be given next of a method of controlling the display device 1 (display method) with reference to FIG. 5. FIG. 5 is a flow chart representing an exemplary process in the display device 1.

Referring to FIG. 5, if a video signal is inputted (S1), the metadata acquisition unit 21 acquires metadata. The acquired metadata is outputted to the tone curve calculation unit 32 via the display mode management unit 22. The acquired metadata may be outputted directly to the tone curve calculation unit 32 from the metadata acquisition unit 21 without going via the display mode management unit 22. The power consumption control unit 24 calculates the total power consumption and luminance ratio corresponding to a display ratio (S2, the power consumption calculation step).

The display mode management unit 22 generates power consumption data on the basis of a result of the calculation (S3). The display mode management unit 22 compares the generated power consumption data and the luminance ratio (S4). The display mode management unit 22 compares the power consumption data and the luminance ratio to determine an available value range for the display ratio (S5, the ratio determining step). The display mode management unit 22 then selects a single display ratio in the available value range by a predetermined method, to determine a display ratio (scale-down or cut-out ratio) to be applied (S6, the ratio determining step). The display mode management unit 22 outputs display mode parameters including the determined display ratio to the display mode switching unit 31.

The display mode switching unit 31 generates a scaled-down or cut-out video in accordance with the display mode parameters and outputs an adjusted video signal representing the scaled-down or cut-out video to the tone curve processing unit 33 (S7, the scaled-down or cut-out video generation step). The tone curve calculation unit 32 calculates a look-up conversion table and outputs a result of the calculation to the tone curve processing unit 33 as a tone curve parameter while S2 to S7 is being implemented. The tone curve processing unit 33 applies a tone curve based on the tone curve parameter to the adjusted video signal to generate a processed video signal for output to the luminance calculation and video signal correction unit 34 (S8).

The luminance calculation and video signal correction unit 34 performs local dimming on the processed video signal to generate a corrected video signal and luminance data (S9, the local dimming processing step). The luminance calculation and video signal correction unit 34 outputs the corrected video signal to the display panel 12 and outputs the luminance data to the backlight 13 via the power consumption control unit 24. The scaled-down or cut-out video is hence displayed on the display panel 12 on the basis of the local dimming function (S10, the display control step).

### Effects

As described here, the display device 1 displays a video in accordance with a scale-down or cut-out ratio determined on the basis of the relationship between the pre-estimated maximum display luminance L2 and the preset, specified display luminance L1. The display device 1 is therefore capable of a faithful luminance display of a video up to the specified display luminance L1.

The display device 1 therefore does not display a video with unintended luminance, but is capable of a display faithful to the original luminance of the video. In other words, the display device 1 is capable of ensuring a video display up to the specified display luminance L1 (prescribed high luminance region), so that the display luminance of the video does not vary from one device to the other. The display device 1 is capable of preventing the reproducibility of an input video for a displayed video from decreasing under some display conditions, for example, preventing the maximum display luminance in displaying a video from decreasing depending on the video signal.

### Embodiment 2

The following will describe another embodiment of the present disclosure. For convenience of description, members of the present embodiment that have the same function as members of the previous embodiment are indicated by the same reference numerals, and description thereof is omitted.

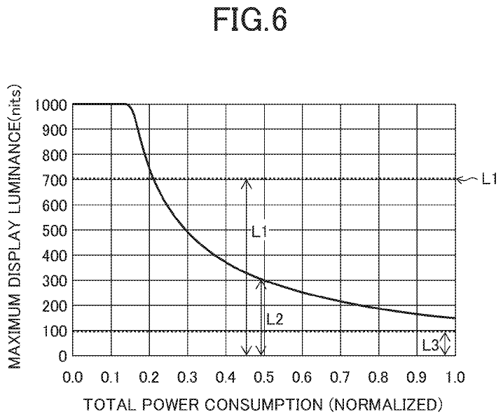

FIG. 6 is a graph representing a relationship between the total power consumption of the backlight 13 and the maximum display luminance L2 of the display device 1. In this graph, a secondary video display luminance L3 is specified such that when a video is displayed in accordance with the scale-down or cut-out ratio determined by the display mode management unit 22, a video other than the video displayed in accordance with the scale-down or cut-out ratio (“a secondary video”) can be displayed. The display mode management unit 22 uses, as a luminance ratio ((L2−L3)/L1), the ratio of a difference obtained by subtracting the secondary video display luminance L3 from the maximum display luminance L2 to the specified display luminance L1.

The secondary video display luminance L3 is a display luminance for displaying the secondary video. In other words, the secondary video display luminance L3 is a display luminance for producing a multivideo display (multi-image display). The secondary video is either a video other than the scaled-down HDR video or a video for an area outside the cut-out area R22 contained in a cut-out video and may be, for example, an SDR video.

For instance, when the specified display luminance L1 is equal to 700 nits, the maximum display luminance L2 is equal to 300 nits, and the secondary video display luminance L3 is equal to 100 nits, the power consumption control unit 24 calculates a luminance ratio, (300−100)/700 nits. The display mode management unit 22 receives a result of this calculation (luminance ratio) as a feedback gain value and compares the luminance ratio with power consumption data.

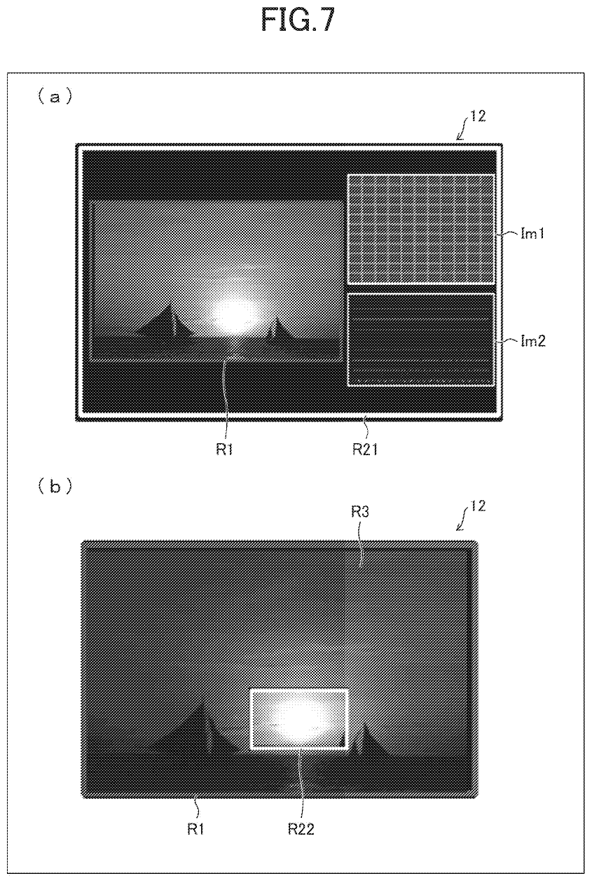

FIG. 7 is a set of illustrations of exemplary display screens in accordance with the present embodiment, with (a) of FIG. 7 showing an exemplary multivideo display screen generated when a scaled-down video is displayed and (b) of FIG. 7 showing an exemplary multivideo display screen generated when a cut-out video is displayed.

In (a) of FIG. 7, two SDR videos Im1 and Im2 other than a scaled-down HDR video (video entire area R1) are displayed as secondary videos. In this example, the secondary video may be a video containing various additional information. The display mode management unit 22 determines a scale-down ratio for the HDR and the secondary videos by taking the number or size of the secondary videos into account.

In (b) of FIG. 7, a secondary area R3 is displayed as a secondary video. The secondary area R3 is a part of an HDR video (video entire area R1) as a cut-out video outside the cut-out area R22 and has its luminance adjusted in such a manner that the total power consumption is not exceeded. The “multivideo display” in the present embodiment encompasses both the display formats shown in (a) and (b) of FIG. 7.

As described here, the display device 1 in accordance with the present embodiment is capable of displaying an HDR video up to the specified display luminance L1 with the scale-down or cut-out ratio determined by the display mode management unit 22. The display device 1 in accordance with the present embodiment is also capable of displaying a scaled-down or cut-out HDR video in multivideo format. In other words, the display device 1 in accordance with the present embodiment is capable of producing a multivideo display while ensuring the preset, specified display luminance L1 so that the total power consumption calculated for an input video is not exceeded.

### Embodiment 3

The following will describe another embodiment of the present disclosure. For convenience of description, members of the present embodiment that have the same function as members of the previous embodiments are indicated by the same reference numerals, and description thereof is omitted.

The display device 1 has been described in Embodiments 1 and 2 as displaying an input video as such on the display panel 12 when the maximum display luminance L2 is higher than or equal to the specified display luminance L1. The display device 1, however, is capable of the following three display modes when the maximum display luminance L2 is higher than or equal to the specified display luminance L1.

(1) The video is displayed as such (across the entire screen).

(2) The video is scaled up before being displayed.

(3) If the video is a moving image and a scaled-down or cut-out video is generated for the preceding frame, a scaled-down or cut-out video is generated and displayed with the same display ratio as the preceding frame or with a display ratio close to that display ratio.

If the maximum display luminance L2 exceeds the specified display luminance L1, there is safely sufficient room to increase the total power consumption. In such a case, a part of the video can be scaled up to fill the entire display area (zoomed display).

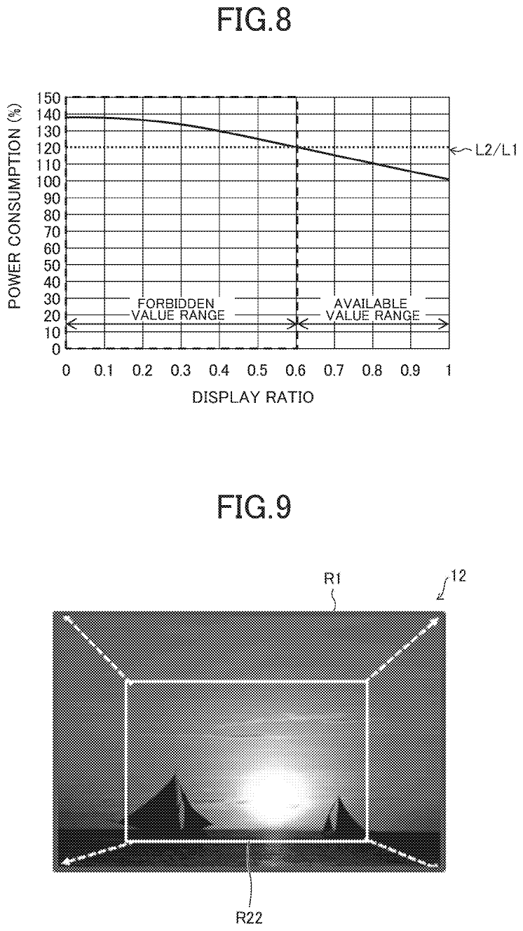

FIG. 8 is a diagram showing other exemplary power consumption data calculated on the basis of an input video signal. If it is determined that the maximum display luminance L2 exceeds the specified display luminance L1, the display mode management unit 22 generates the power consumption data shown in FIG. 8, instead of the power consumption data shown in FIG. 4. Throughout the rest of the present embodiment, the power consumption data shown in FIG. 4 will be referred to as the first set of power consumption data, and the power consumption data shown in FIG. 8 will be referred to as the second set of power consumption data.

The display mode management unit 22 uses the second set of power consumption data to identify the part of the video that will be scaled up to fill the entire display area (i.e., identify the cut-out area R22 that will be cut out as a part of a video).

Similarly to the display ratio for the first set of power consumption data, the display ratio for the second set of power consumption data indicates the relationship between a relative value obtained based on the total power consumption and a display ratio. Since the second set of power consumption data is used to cut out a part of a video, the display ratio for the second set of power consumption data is set to less than or equal to 1. In other words, the display ratio only includes a cut-out ratio.

The second set of power consumption data, similarly to the first set of power consumption data, is generated by calculating in advance a maximum total power consumption for various display ratios with respect to an input video.

In the present embodiment, since the cut-out area R22 is scaled up to fill the entire display area, a smaller cut-out area R22 (lower display ratio) translates into a larger scale-up ratio, hence a larger power consumption for the scaled-up display. A higher proportion of high luminance regions in the cut-out area R22 also translates into a larger power consumption for the scaled-up display. When the cut-out area R22 is smaller in size than the high luminance regions, the power consumption saturates at its maximum value.

The power consumption is therefore larger when the video is scaled-up for display than when the display ratio is equal to 1 (when the whole video is displayed across the entire display area). Specifically, the power consumption is a minimum when the display ratio is equal to 1 and a maximum when the display ratio is equal to 0.

Therefore, in a case where the second set of power consumption data is generated on the basis of a result of the calculation of the maximum total power consumption for various display ratios, if the relative value obtained based on the total power consumption for the display ratio of 1 is taken as 100% in the second set of power consumption data, the relative value obtained based on the total power consumption increases with a decreasing display ratio.

If it is determined that the luminance ratio (L2/L1) calculated on the basis of the input video signal exceeds 1, the display mode management unit 22 compares the luminance ratio (L2/L1) with the second set of power consumption data calculated on the basis of the video signal as in Embodiment 1. The display mode management unit 22, as a result of the comparison, designates the range of the display ratio where the relative value obtained based on the total power consumption is less than or equal to the luminance ratio as an available value range.

Assume, as an example, that the specified display luminance L1 is set to 700 nits and also that the total power consumption (in normalized value) calculated by the power consumption control unit 24 is equal to approximately 0.17. The graph in FIG. 3 shows that the maximum display luminance L2 is equal to approximately 840 nits under these conditions. The luminance ratio L2/L1 is therefore calculated to be equal to 840/700=1.2 (120%). By comparing this luminance ratio with the second set of power consumption data, the range equal to or above approximately 0.6, where the relative value obtained based on the total power consumption is less than or equal to the luminance ratio, is designated as an available value range, and the range of display ratio outside the available value range is designated as a forbidden value range, as shown in FIG. 8.

FIG. 9 is an illustration of a scaled-up display of the cut-out area R22. FIG. 9 illustrates a video displayed across the entire display area before being cut out. The display mode management unit 22 specifies a display ratio (cut-out ratio) of 1, which falls in the available value range, as the display mode. The display control unit 23 generates such a display video that the cut-out area R22 obtained by cutting out a part of the video entire area R1 in accordance with the cut-out ratio is scaled up and displayed across the entire display area on the display panel 12, as shown in FIG. 9.

As described here, the display device 1 in accordance with the present embodiment is capable of producing a scaled-up display of the cut-out area R22 while ensuring the preset, specified display luminance (accurate display luminance) if there is sufficient room to increase the total power consumption.

### Variation Example

The cut-out area R22, instead of being scaled up to fill the entire display area, may be scaled up to a size smaller than the display area for display. For instance, the cut-out area R22 may be cut out with respect to the scaled-down video and scaled up to a size of a scaled-down video for display.

The cut-out area R22 is neither scaled up nor scaled down as described in Embodiment 1. The cut-out area R22 is therefore displayed in dot-by-dot mode. Meanwhile, the scaled-down video is obtained by scaling down an input video. The display device 1 in accordance with the present variation example is capable of displaying a part of a scaled-down image in a manner close to dot-by-dot mode, by cutting out the cut-out area R22 from a scaled-down video and scaling up and displaying the cut-out area R22. In other words, the display device 1 in accordance with the present variation example is capable of displaying a part of a scaled-down image with a resolution close that of the original video (input video).

Specifically, the display mode management unit 22 generates the first set of power consumption data (see FIG. 4) and the second set of power consumption data (see FIG. 8) on the basis of an input video signal. The display mode management unit 22 generates a scaled-down video by using the first set of power consumption data, and then scales up and displays the scaled-down video using the second set of power consumption data. In other words, the display mode management unit 22 scales up and displays a scaled-down video using two display-ratio-related parameters (i.e., the first and second sets of power consumption data).

If the maximum display luminance L2 is lower than the specified display luminance L1, the display mode management unit 22 generates the first set of power consumption data and then compares the first set of power consumption data with a luminance ratio to determine an available value range, similarly to Embodiments 1 and 2.

In the present variation example, the display mode management unit 22 specifies, in the available value range in advance, a display ratio corresponding to a value at which the relative value obtained based on the total power consumption can be smaller than L2/L1×100 (%). This display ratio is specified, for example, to such a value as to reduce the relative value obtained based on the total power consumption as much as possible. The display ratio may be specified by a user.

As described in Embodiment 1, the first set of power consumption data varies depending on the display device 1 when the display ratio is greater than 1 and decreases primarily with a decrease in the area of the video entire area R1. Therefore, when the display ratio is greater than 1, the relationship between the display ratio and the relative value obtained based on the total power consumption does not vary with the video signal.

The display mode management unit 22 scales down an input video with a predetermined display ratio (scale-down ratio). As an example, suppose that the predetermined display ratio is equal to 2.25 and also that the specified display luminance L1 is equal to 700 nits, and the maximum display luminance L2 is equal to 300 nits. Under these conditions, the relative value obtained based on the total power consumption corresponding to the predetermined display ratio of 2.25 (prescribed relative value W1) is equal to approximately 25%, and the luminance ratio (L2/L1) is given by 300/700, which is approximately equal to 0.43 (43%). Because the luminance ratio L2/L1 (43%) is greater than the prescribed relative value W1 (25%), there is more room to increase the total power consumption when a scaled-down video is generated with a display ratio of 2.25 than when a scaled-down video is generated with a display ratio of approximately 1.6. In other words, there is room to increase the total power consumption because the total power consumption assumed in displaying a scaled-down video for identifying the cut-out area R22 is smaller than the limit value of the total power consumption or than a value near the limit value. The display mode management unit 22 can therefore generate the second set of power consumption data for the scaled-down video. In other words, the second set of power consumption data is generated by assuming that the scaled-down video is the video entire area R1.

By comparing a second power consumption table with a power consumption ratio ((L2/L1)/W1), the display mode management unit 22 designates a range of the display ratio where the power consumption ratio is not exceeded as an available value range. In other words, in this example, the display mode management unit 22 compares the second power consumption table by using a power consumption ratio as a luminance ratio. The display mode management unit 22 can cut out the cut-out area R22 from a scaled-down video by specifying a display ratio in the available value range. This configuration enables a scaled-up display of the cut-out area R22 up to the size of a scaled-down video in a manner close to dot-by-dot mode.

The display device 1 not in accordance with the present variation example uses a single parameter related to a display ratio (i.e., either one of the first and second sets of power consumption data) to produce a display up to a specified display luminance. In such a case, the display mode management unit 22 automatically generates (i.e., determines and alters) the first set of power consumption data or the second set of power consumption data every time an video signal is inputted.

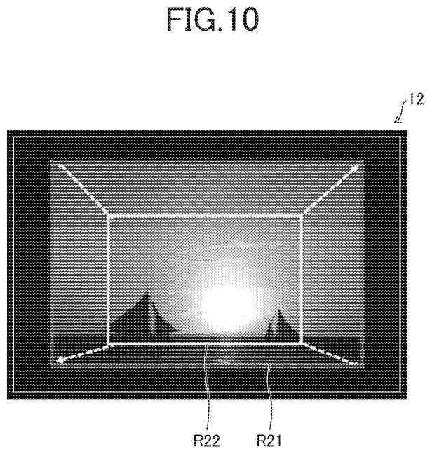

FIG. 10 is an illustration of a scaled-up display of the cut-out area R22 on the display device 1 in accordance with the present variation example. FIG. 10 illustrates a scaled-down video being displayed before being cut out. Referring to FIG. 10, the display mode management unit 22, after generating a scaled-down video, cuts out the cut-out area R22 from the scaled-down video by using the scaled-down video as the display area R21. The display mode management unit 22 then scales up and displays the cut-out area R22 up to the display area R21 as the scaled-down video.

As described here, the display device 1 in accordance with the present variation example is capable of scaling up and displaying the cut-out area R22 not across the entire display area, but across an area smaller than the display area. The display device 1 in accordance with the present variation example also enables a display of a scaled-down video in a manner close to dot-by-dot mode while ensuring the preset, specified display luminance (accurate display luminance), by generating a scaled-down video such that there is sufficient room to increase power consumption.

### Embodiment 4

The following will describe another embodiment of the present disclosure. For convenience of description, members of the present embodiment that have the same function as members of the previous embodiments are indicated by the same reference numerals, and description thereof is omitted.

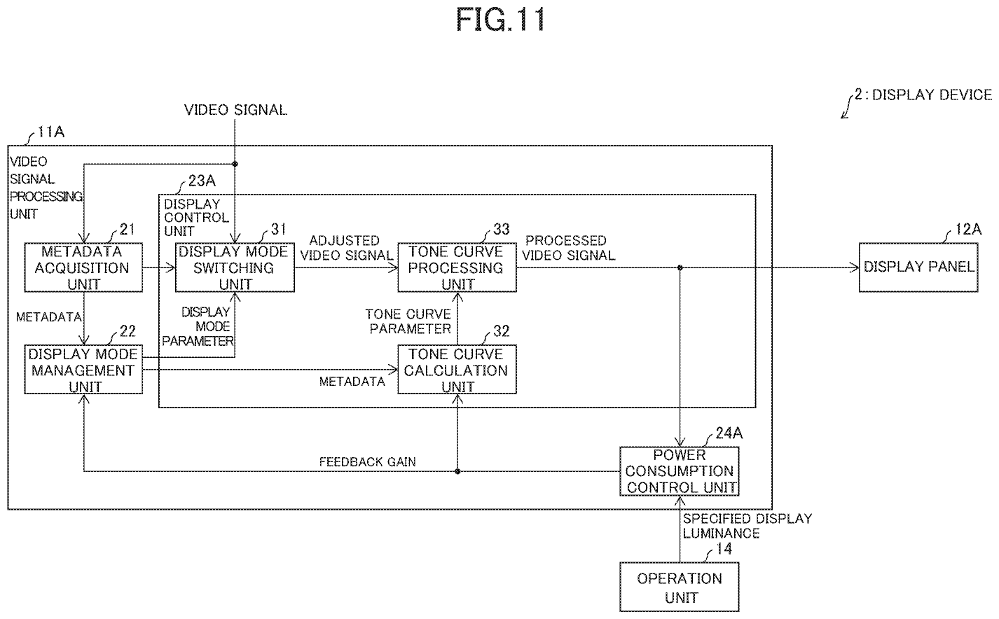

FIG. 11 is a block diagram of an exemplary structure of a display device 2 in accordance with the present embodiment. The display device 1 in Embodiment 1 includes a liquid crystal panel as the display panel 12 and further includes the backlight 13. This is by no means intended to limit the scope of the present disclosure. The display device 2 in the present embodiment includes a display panel 12A (display unit) that in turn includes a plurality of self-luminous elements (light sources, display elements) as shown in FIG. 11. The display panel 12A may be, for example, an OLED display device, a plasma display device, or another display device including self-luminous elements.

The display device 2, including the display panel 12A, includes no backlight 13 unlike the display device 1. Since the display device 2 includes no backlight 13, a video signal processing unit 11A includes no luminance calculation and video signal correction unit 34 in a display control unit 23A and includes a power consumption control unit 24A in place of the power consumption control unit 24.

In other words, the display device in accordance with the present disclosure is generally applicable to display devices that include a backlight or a self-luminous element the power consumption of which is variable.

In the display device 2, the display panel 12A is fed with a video signal processed by the tone curve processing unit 33. Each self-luminous element in the display panel 12A emits light with a luminance corresponding to a light-emitting current value that is predetermined one by one correspondingly to a pixel value (e.g., gray level or luminance value) of a pixel represented by a processed video signal.

The power consumption control unit 24A manages in such a manner as to maintain the total power consumption of the display panel 12A less than or equal to a prescribed value, by calculating the total power consumption of the self-luminous elements in the display panel 12A in displaying an input video.

Unlike the power consumption control unit 24, the power consumption control unit 24A is fed with a processed video signal (not luminance data) from the tone curve processing unit 33. The processed video signal (i.e., inputted video signal) corresponds to the light-emitting current value for each picture element or pigment in the display panel 12A. The power consumption control unit 24A therefore calculates the total power consumption of the display panel 12A from the pixel values represented by the video signal.

The power consumption control unit 24A, unlike the power consumption control unit 24, logically has no so-called local dimming function.

The power consumption control unit 24A has the same functions as the power consumption control unit 24, except for those functions described above. In other words, the power consumption control unit 24A, for example, calculates the total power consumption of the display panel 12A corresponding to a display ratio and calculates the luminance ratio (L2/L1). Therefore, similarly to Embodiment 1, the display device 2 is capable of improving reproducibility of the original luminance of the video in displaying the video, by displaying the video in accordance with a scale-down or cut-out ratio.

Each self-luminous element has a maximum current at which the element can emit light. In other words, each self-luminous element can emit light up to a luminance corresponding to the maximum current. The total power consumption of the entire display panel 12A can however vary greatly depending on whether some of the self-luminous elements in the display panel 12A are emitting light or all the self-luminous elements in the display panel 12A are emitting light. In other words, the limit value of the display luminance of the display panel 12A can vary with the video displayed on the display panel 12A and the display format of the video.

If only a part of the display panel 12A emits light, the power consumption control unit 24A outputs, to the display mode management unit 22 and the tone curve calculation unit 32, a maximum display luminance of the display panel 12A that corresponds to the total power consumption as a feedback gain value. This output notifies the display mode management unit 22 and the tone curve calculation unit 32 of the self-luminous elements being able to emit light with a higher luminance. The case where only a part of the display panel 12A emits light is, in other words, a case where the total power consumption is relatively low and a maximum display luminance value is relatively large.

### Software Implementation

The control blocks of the display devices 1 and 2 (particularly, those units included in the video signal processing units 11 and 11A) may be implemented by logic circuits (hardware) fabricated, for example, in the form of an integrated circuit (IC chip) and may be implemented by software.

In the latter form of implementation, the display devices 1 and 2 include a computer that executes instructions from programs or software by which various functions are implemented. This computer includes among others at least one processor (control device) and at least one storage medium containing the programs in a computer-readable format. The processor in the computer then retrieves and runs the programs contained in the storage medium, thereby achieving the object of the present disclosure. The processor may be, for example, a CPU (central processing unit). The storage medium may be a “non-transitory, tangible medium” such as a ROM (read-only memory), a tape, a disc/disk, a card, a semiconductor memory, or programmable logic circuitry. The display devices 1 and 2 may further include, for example, a RAM (random access memory) for loading the programs. The programs may be supplied to the computer via any transmission medium (e.g., over a communications network or by broadcasting waves) that can transmit the programs. The present disclosure, in an aspect thereof, encompasses data signals on a carrier wave that are generated during electronic transmission of the programs.

### General Description

The present disclosure, in aspect 1 thereof, is directed to a display device including: a power consumption calculation unit configured to calculate total power consumption of a plurality of light sources in displaying an input video; a ratio determining unit configured to determine a scale-down ratio or a cut-out ratio for the video based on a relationship between a prescribed maximum display luminance for a given pixel and a preset, specified display luminance that is a maximum value of display luminance for a faithful luminance display, the prescribed maximum display luminance being predetermined so as to be achievable at the total power consumption calculated by the power consumption calculation unit; and a display control unit configured to process the video in accordance with the scale-down ratio or cut-out ratio determined by the ratio determining unit.

A conventional display device is only capable of displaying a video up to a prescribed maximum display luminance determined for a prescribed total power consumption. In other words, the video display luminance in conventional display devices varies from one device to the other.

According to the configuration, the display device displays a video in accordance with the scale-down ratio or cut-out ratio determined on the basis of the relationship between the prescribed maximum display luminance and the specified display luminance. The display device can hence display videos up to the specified display luminance without consuming more power than the prescribed total power consumption. In other words, the display device in accordance with the present disclosure, unlike the conventional display device, can display a video such that the video display luminance does not vary from one device to the other. It hence becomes possible to improve the reproducibility of the original luminance of a video in displaying the video.

By setting the specified display luminance approximately to a value at which a faithful display of the video can be produced, the display device can faithful reproduce the original luminance of the video, especially when the prescribed maximum display luminance is less than the specified display luminance.

In aspect 2 of the present disclosure, the display device of aspect 1 may further include a display unit configured to display the display video and may be configured such that the ratio determining unit determines the scale-down ratio or cut-out ratio for the video by: generating power consumption data representing a relationship between (i) either a display ratio that is a ratio of a size of a display area of the display unit to a size of the video to be displayed in the display area or a display ratio that is a ratio of a size of a cut-out area to be cut out from the video to a size of the video to be displayed in the display area of the display unit and (ii) a relative value obtained based on total power consumption corresponding to the display ratio; and comparing the power consumption data with a luminance ratio that is a ratio of the prescribed maximum display luminance to the specified display luminance.

According to the configuration, it is possible to determine a scale-down ratio or cut-out ratio with which a video can be displayed up to the specified display luminance, by comparing the power consumption data and the luminance ratio.

In aspect 3 of the present disclosure, the display device of aspect 2 may be configured such that the ratio determining unit determines, as an available value range, the display ratio where the relative value obtained based on the total power consumption is less than or equal to the luminance ratio in the power consumption data, the scale-down ratio or cut-out ratio for the video being set to a value in the available value range.

According to the configuration, the display device can display a video up to the specified display luminance by scaling down or cutting out a video with a scale-down ratio or cut-out ratio that falls in the available value range.

In aspect 4 of the present disclosure, the display device of aspect 2 or 3 may be configured such that when the video is displayed in accordance with the scale-down ratio or cut-out ratio determined by the ratio determining unit, a secondary video display luminance is specified so as to display a secondary video other than the video displayed in accordance with the scale-down ratio or cut-out ratio, and the ratio determining unit uses, as the luminance ratio, a ratio of a value obtained by subtracting the secondary video display luminance from the prescribed maximum display luminance to the specified display luminance.

According to the configuration, the display device can display a secondary video as well as display a video up to the specified display luminance, without consuming more power than the prescribed total power consumption. In other words, the display device can produce a multivideo display without consuming more power than the prescribed total power consumption.

In aspect 5 of the present disclosure, the display device of any one of aspects 1 to 3 may be configured such that if there is sufficient room to increase the total power consumption, the display control unit processes the video so as to produce a scaled-up display of a video cut out in accordance with the cut-out ratio determined by the ratio determining unit.

According to the configuration, if there is sufficient room to increase the total power consumption, the display device can scale up and display the video cut out in accordance with the cut-out ratio by relying on the sufficient room to increase the total power consumption.

In aspect 6 of the present disclosure, the display device of any one of aspects 1 to 5 may further include a display unit configured to display the video and may be configured such that the display unit includes: a liquid crystal panel; and a backlight including the plurality of light sources, the backlight being divided into a plurality of areas and allowing separate luminance adjustment for each of the plurality of areas.

Accordingly the configuration, the display device, including a liquid crystal panel, can display a video in such a manner that the video display luminance does not vary from one device to the other. It hence becomes possible to improve the reproducibility of the original luminance of a video in displaying the video.

In aspect 7 of the present disclosure, the display device of any one of aspects 1 to 5 may further include a display unit configured to display the video and may be configured such that the display unit is a display panel including a plurality of self-luminous elements as the plurality of light sources.

According to the configuration, display devices including a display panel including a plurality of self-luminous elements such as OLED display devices can display a video in such a manner that the video display luminance does not vary from one device to the other. It hence becomes possible to improve the reproducibility of the original luminance of a video in displaying the video.

The present disclosure, In aspect 8 thereof, is directed to a display method including: the power consumption calculation step of calculating total power consumption of a plurality of light sources in displaying an input video; the ratio determining step of determining a scale-down ratio or a cut-out ratio for the video based on a relationship between a prescribed maximum display luminance for a given pixel and a preset, specified display luminance that is a maximum value of display luminance for a faithful luminance display, the prescribed maximum display luminance being predetermined so as to be achievable at the total power consumption calculated in the power consumption calculation step; and the display control step of processing the video in accordance with the scale-down ratio or cut-out ratio determined in the ratio determining step.

The method achieves the same advantages as does the display device in accordance with aspect 1.

The display device in accordance with any aspect of the present disclosure may be implemented on a computer, in which case the present disclosure encompasses a display control program for a display device and a computer-readable storage medium containing the program, the display control program implementing the display device on a computer by causing the computer to function as the various units of the display device.

### Additional Note

The present disclosure is not limited to the description of the embodiments above and may be altered within the scope of the claims. Embodiments based on a proper combination of technical means disclosed in different embodiments are encompassed in the technical scope of the present disclosure. Furthermore, new technological features can be created by combining different technological means disclosed in the embodiments.

### Cross-reference to Related Applications

The present application claims the benefit of priority to Japanese Patent Application, Tokugan, No. 2018-001777 filed on Jan. 10, 2018, the entire contents of which are incorporated herein by reference.

### REFERENCE SIGNS LIST

1, 2 Display Device
12, 12A Display Panel (Display Unit)
13 Backlight (Display Unit, Light Source)
22 Display Mode Management Unit (Ratio Determining Unit)
23, 23A Display Control Unit
24, 24A Power Consumption Control Unit (Power Consumption Calculation Unit)
Im1, Im2 SDR Video (Secondary Video)
L1 Specified Display Luminance
L2 Maximum Display Luminance (Prescribed Maximum Display Luminance)
L3 Secondary Video Display Luminance
R3 Secondary Area (Secondary Video)

1. A display device comprising:
a power consumption calculation unit configured to calculate total power consumption of a plurality of light sources in displaying an input video;
a ratio determining unit configured to determine a scale-down ratio or a cut-out ratio for the video based on a relationship between a prescribed maximum display luminance for a given pixel and a preset, specified display luminance that is a maximum value of display luminance for a faithful luminance display, the prescribed maximum display luminance being predetermined so as to be achievable at the total power consumption calculated by the power consumption calculation unit; and
a display control unit configured to process the video in accordance with the scale-down ratio or cut-out ratio determined by the ratio determining unit.

2. The display device according to claim 1, further comprising a display unit configured to display the video, wherein
the ratio determining unit determines the scale-down ratio or cut-out ratio for the video by:
generating power consumption data representing a relationship between either a display ratio that is a ratio of a size of a display area of the display unit to a size of the video to be displayed in the display area or a display ratio that is a ratio of a size of a cut-out area to be cut out from the video to a size of the video to be displayed in the display area of the display unit and a relative value obtained based on total power consumption corresponding to the display ratio; and
comparing the power consumption data with a luminance ratio that is a ratio of the prescribed maximum display luminance to the specified display luminance.

3. The display device according to claim 2, wherein the ratio determining unit determines, as an available value range, the display ratio where the relative value obtained based on the total power consumption is less than or equal to the luminance ratio in the power consumption data, the scale-down ratio or cut-out ratio for the video being set to a value in the available value range.

4. The display device according to claim 2, wherein
when the video is displayed in accordance with the scale-down ratio or cut-out ratio determined by the ratio determining unit, a secondary video display luminance is specified so as to display a secondary video other than the video displayed in accordance with the scale-down ratio or cut-out ratio, and
the ratio determining unit uses, as the luminance ratio, a ratio of a value obtained by subtracting the secondary video display luminance from the prescribed maximum display luminance to the specified display luminance.

5. The display device according to claim 1, wherein if there is sufficient room to increase the total power consumption, the display control unit processes the video so as to produce a scaled-up display of a video cut out in accordance with the cut-out ratio determined by the ratio determining unit.

6. The display device according to claim 1, further comprising a display unit configured to display the video, wherein
the display unit comprises:
a liquid crystal panel; and
a backlight including the plurality of light sources, the backlight being divided into a plurality of areas and allowing separate luminance adjustment for each of the plurality of areas.

7. The display device according to claim 1, further comprising a display unit configured to display the video, wherein
the display unit is a display panel including a plurality of self-luminous elements as the plurality of light sources.

8. A display method comprising:
the power consumption calculation step of calculating total power consumption of a plurality of light sources in displaying an input video;
the ratio determining step of determining a scale-down ratio or a cut-out ratio for the video based on a relationship between a prescribed maximum display luminance for a given pixel and a preset, specified display luminance that is a maximum value of display luminance for a faithful luminance display, the prescribed maximum display luminance being predetermined so as to be achievable at the total power consumption calculated in the power consumption calculation step; and
the display control step of processing the video in accordance with the scale-down ratio or cut-out ratio determined in the ratio determining step.

9. A non-transitory computer-readable storage medium storing a display control program causing a computer to function as the display device according to claim 1, the program causing the computer to function as the power consumption calculation unit, the ratio determining unit, and the display control unit.
